(19) United States
(12) Patent Application Publication
(10) Pub. No.: US 2010/0257339 A1
(43) Pub. Date: Oct. 7, 2010

(54) Dependency Matrix with Improved Performance

(75) Inventors: Mary D. Brown, Austin, TX (US); William E. Burky, Austin, TX (US); Dung Q. Nguyen, Austin, TX (US); Todd A. Venton, Austin, TX (US)

Correspondence Address: IBM Corporation (PEC);c/o Patrick E. Caldwell, Esq., The Caldwell Firm, LLC, PO Box 59655, DALLAS, TX, 75229-0655, US

(73) Assignee: International Business Machines Corporation, Armonk, NY (US)

(21) Appl. No.: 12/417,831

(22) Filed: Apr. 3, 2009

(51) Int. Cl. G06F 9/30

(52) U.S. Cl. 712/214; 712/216; 712/E09.016

(57) ABSTRACT

A processor having a dependency matrix comprises a first array comprising a plurality of cells arranged in a plurality of columns and a plurality of rows. Each row represents an instruction in a processor execution queue and each cell in the first array represents a dependency relationship between two instructions in the processor execution queue. A clear port couples to the first array and clears a column of the first array. A producer status module couples to the clear port and the first array and determines an execution status of a producer instruction, wherein the producer instruction is an instruction in the processor execution queue. An available-status port couples to the first array and the producer status module and sets a read wordline column corresponding to the producer instruction based on the execution status of the producer instruction. The available-status port deasserts the read wordline column in response to a selection of the producer for execution. The available-status port reasserts the read wordline column in the event the producer status module determines the producer instruction has been rejected. The clear port clears the column of the first array corresponding to the producer instruction in the event the producer status module determines the producer instruction has been executed.

This invention was made with United States Government support under Agreement No. HR0011-07-9-0002 awarded by DARPA. The Government has certain rights in the invention.

### TECHNICAL FIELD

The present invention relates generally to the field of computer processing and instruction scheduling and, more particularly, to a system and method for a dependency matrix with improved performance.

### BACKGROUND

Modern electronic computing systems, such as microprocessor systems, typically include a processor and datapath configured to receive and process instructions. Certain systems allow for out of order instruction execution, wherein instructions can issue and be executed out of their order in the underlying program code. An out of order execution system must account for dependencies between instructions.

Generally, a dependency occurs where an instruction requires data from sources that are themselves the result of another instruction. For example, in the instruction sequence:

### ADD $8, $7, $5

### SW $9, (0)$8

The ADD (add) instruction adds the contents of register $7 to the contents of register $5 and puts the result in register $8. The SW (store word) instruction stores the contents of register $9 at the memory location address found in $8. As such, the SW instruction must wait for the ADD instruction to complete before storing the contents of register $8. The SW instruction therefore has a dependency on the ADD instruction. The illustrated dependency is also known as a read-after-write (RAW) dependency.

One common approach to tracking dependencies is a “dependency matrix,” such as that described in U.S. Pat. Nos. 6,065,105 and 6,334,182. Generally, a conventional dependency matrix includes rows and columns. Each bit or element, i.e., the intersection of one row and one column, corresponds to a dependency of an instruction in the issue queue. Each instruction in the issue queue is associated with a particular row in the dependency matrix, with the read-after-write (RAW) dependencies noted by bits set on a given column within that row.

As a given resource becomes available, the dependency matrix clears the column associated with that resource, setting all locations in the column to zero. Once a given instruction (row) has all of its RAW dependencies resolved, i.e., once all columns in that row have been set to zero, then the instruction is ready to issue.

As new instructions enter the issue queue, allocation logic assigns the new instructions to a position within the dependency matrix. The dependency matrix logic checks sources for that instruction against a destination register file. A match between an entering instruction's source and a pending instruction's destination indicates that the entering instruction is dependent on the pending entry, and the dependency matrix logic sets the bit in the appropriate position in the dependency matrix. The newly entered instruction will not issue from the issue queue until after the instruction on which it depends has issued, as indicated by the dependency matrix.

Previous designs clear bits of the dependency matrix in, for example, column j, when the producer instruction in row j executes, and the consumer instruction is ready for execution (sometimes referred to as “waking up” the consumer instruction). The problem is that if the producer instruction in row j gets rejected, there is no way to put its dependent instructions in the matrix (the consumers) back to sleep (awaiting execution scheduling) without re-writing rows of the matrix.

One known solution is to provide a separate queue for replayed or rejected instructions. However, this solution requires extra area and hardware complexity to support the additional queues. Some systems instead attempt to mitigate the re-write penalty, by re-writing the matrix rows more effectively. These approaches, however, typically require additional write ports into the queue, or arbitration for existing write ports. As such, both known solutions require additional area, hardware, and design complexity.

Therefore, there is a need for a system and/or method for a dependency matrix that addresses at least some of the problems and disadvantages associated with conventional systems and methods.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

A processor having a dependency matrix comprises a first array comprising a plurality of cells arranged in a plurality of columns and a plurality of rows. Each row represents an instruction in a processor execution queue and each cell in the first array represents a dependency relationship between two instructions in the processor execution queue. A clear port couples to the first array and clears a column of the first array. A producer status module couples to the clear port and the first array and determines an execution status of a producer instruction, wherein the producer instruction is an instruction in the processor execution queue. An available-status port couples to the first array and the producer status module and sets a read wordline column corresponding to the producer instruction based on the execution status of the producer instruction. The available-status port deasserts the read wordline column in response to a selection of the producer for execution. The available-status port reasserts the read wordline column in the event the producer status module determines the producer instruction has been rejected. The clear port clears the column of the first array corresponding to the producer instruction in the event the producer status module determines the producer instruction has been executed.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing an instruction dependency tracking system in accordance with a preferred embodiment;

FIG. 2 illustrates a block diagram showing an instruction dependency tracking system in accordance with a preferred embodiment;

FIG. 3 illustrates a high-level flow diagram depicting logical operational steps of an improved instruction dependency tracking method, which can be implemented in accordance with a preferred embodiment; and

FIG. 4 illustrates an example computer system that can be configured in accordance with a preferred embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, user interface or input/output techniques, and the like, have been omitted inasmuch as such details are not considered necessary to obtain a complete understanding of the present invention, and are considered to be within the understanding of persons of ordinary skill in the relevant art.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

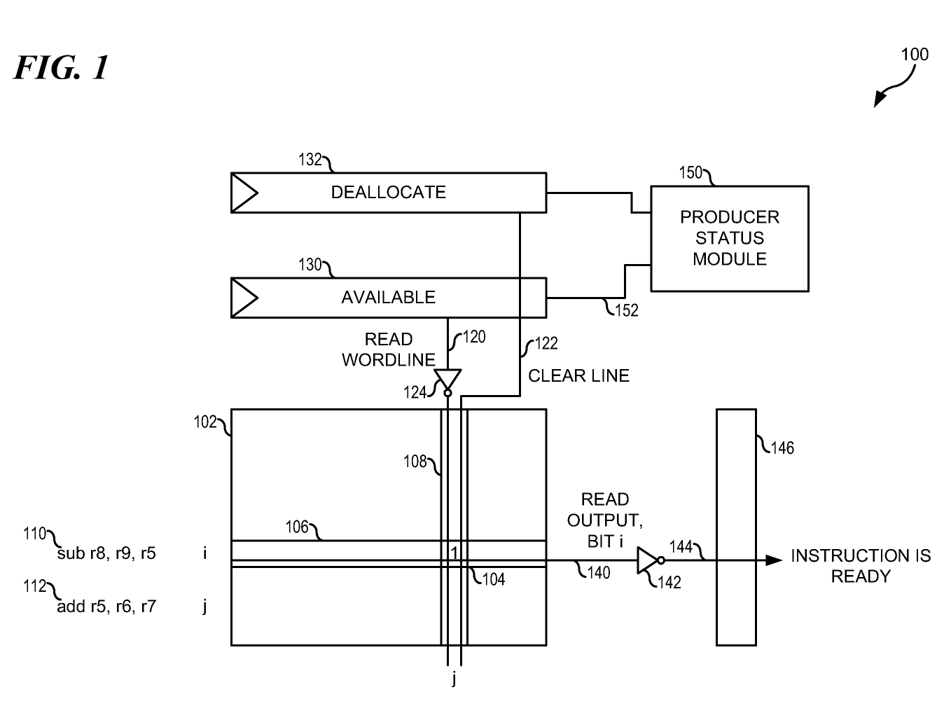

Referring now to the drawings, FIG. 1 illustrates an embodiment of an exemplary instruction dependency tracking system 100. System 100 includes dependency matrix 102. Generally, dependency matrix 102 is an otherwise conventional dependency matrix, modified as described herein. In one embodiment, dependency matrix 102 supports scheduling instructions according to the availability of their register dependences, as described in more detail below. In one embodiment, system 100 implements matrix 102 as a register file. As illustrated, dependency matrix 102 comprises a plurality of cells, such as exemplary cell 104, which hold instruction dependency information.

In particular, cell 104 is disposed at the intersection of row “l” 106 and column “j” 108. Generally, horizontal rows such as row 106 track the dependencies of a single instruction, such as instruction 110, for example, which depends on instruction 112. Generally, vertical columns, such as column 108, indicate the source instructions on which the dependent instruction depends, such as instruction 112, for example. As illustrated, the SUB instruction (110) depends on the result of the ADD instruction (112). As shown, the SUB instruction is in row “l” 106, and the ADD instruction is in row j. Accordingly, matrix 102 sets bit (i,j) (cell 104) to 1, indicating the dependence between the two instructions 110 and 112. Where there is no dependency (such as between instruction 110 and the instruction in row “m” (not shown), the cell formed by row 106 and column “m” (not shown) is “clear” or logic 0, indicating no dependency. Dependency matrix 102 sets and clears each cell as the status of the dependencies change, typically as instructions issue and execute.

In one embodiment, each column of dependency matrix 102 includes a read wordline and a clear line. For example, column 108 includes read wordline 120 and clear line 122. Generally, each read wordline is in a logic high state while the instruction represented by that column remains unexecuted. When the result produced by an instruction becomes available, the associated read wordline changes to a logic low state, driven low by system 100.

In the illustrated embodiment, system 100 includes an “AVAILABLE” latch 130. Generally, latch 130 is an otherwise conventional latch, configured to indicate which instructions' results are available for waking dependent consumers. In one embodiment, when system 100 enqueues an instruction, latch 130 sets a corresponding bit to logic low, indicating that the instruction's results are not yet available for dependent consumers (if any).

In the illustrated embodiment, the bit output feeds the corresponding read wordline, which is then inverted for use by dependency matrix 102. As shown, latch 130 couples to an otherwise conventional inverter 124, the output of which comprises read wordline 120. Thus, when an instruction's results are not available, its corresponding read wordline is in a logic high state. When an instruction's results are available, latch 130 sets the corresponding bit to logic high, which output is inverted (by inverter 124, for example), thereby driving the read wordline into a logic low state. In one embodiment, the read wordline and a read output determine the eligibility for an instruction to be scheduled for execution.

In one embodiment, each row of matrix 102 includes a read output associated with that row. For example, row “i” includes read output, bit i 140. In the illustrated embodiment, the read output for each row is in a logic high state (or “on”) if, for every bit j of the row, where the bit j contains a “1”, the read wordline for that bit j is also on. As such, read output 140, for example, is on when read wordline 120 is on. Thus, read output 140 is on when the sources for an instruction on which the row's instruction depends (i.e., the producer instruction) are not available.

In the illustrated embodiment, read output 140 couples to an otherwise conventional inverter 142. The output of inverter 142 is a ready signal 144, which indicates whether the corresponding instruction is ready for execution and can therefore be scheduled for execution. In one embodiment, each read output of matrix 102 together comprises a ready vector 146. So configured, ready vector 146 indicates which instructions represented in matrix 102 are ready to be issued for execution.

In the illustrated embodiment, system 100 includes a “REALLOCATE” latch 132, coupled to clear line 122. Generally, latch 132 is an otherwise conventional latch, configured to indicate which instructions have been deallocated from the instruction queue (typically because they have been executed), and therefore which columns in matrix 102 can be cleared of dependency information associated with the deallocated instruction. In one embodiment, when system 100 executes an instruction, latch 132 sets a bit corresponding to that executed instruction. The clear line 122 associated with the bit clears the column associated with the deallocated instruction. Generally, latch 132 indicates which instructions are being deallocated from the queue, and the latch 132 bitwise output forms the clear wordlines, such as clear line 122.

Thus, in one embodiment, system 100 asserts clear line 122, at some time after an instruction is deallocated from the queue, and before re-allocating the now-vacant entry to another instruction. As described above, asserting the clear wordline clears out the contents of the associated column. As such, system 100 assists in ensuring that there are no false dependences on the younger instructions subsequently allocated.

As described above, system 100 deallocates instructions when they have executed. In one embodiment, system 100 includes a producer status module (PSM) 150, coupled to latch 130 and latch 132. In one embodiment, PSM 150 is configured to gate the clock signal coupling to latch 130 through link 152, described in more detail below. In the illustrated embodiment, PSM 150 is a circuit or circuits configured to monitor the state of one or more pending instructions, and to pass that state information to other components of system 100. Thus, PSM 150 generally represents those components of a typical computer instruction processing system that, for example, indicate to latch 130 that the results of the instruction are available, indicate to latch 132 that system 100 is deallocating an instruction, and/or read ready vector 146.

In particular, in one embodiment PSM 150 determines whether an instruction has issued speculatively and whether the instruction issue mis-speculated. That is, in some systems, certain instructions can issue “speculatively,” in advance of confirmation that the instruction's required inputs are ready. Where the inputs are ready, the instruction executes normally. Where the inputs are not ready, the instruction execution fails, (it “mis-speculated”) and must be rescheduled for execution. As described above, typical approaches to addressing mis-speculation require additional area to support a reject and/or instruction replay queue, or require that the consumer instruction's rows be rewritten when the system re-queues the producer instruction. System 100 (and system 200, described below) avoids these problems.

That is, in previous dependency matrix designs, the system clears the dependency matrix columns as soon as it is time to wake up consumer instructions for execution scheduling. As described above, however, system 100 does not modify the matrix 102 array contents at wakeup time. Instead, system 100 (through latch 132 and clear line 122) does not clear the contents of a producer instruction's column until the producer instruction's scheduling time is non-speculative and known to be correct.

More particularly, in one embodiment, at some time after an instruction has been selected for execution, system 100 (through latch 130 and inverter 124) deasserts the read wordline 120 associated with the selected instruction. If PSM 150 later determines that the selected instruction has been rejected as a result of a scheduling mis-speculation, system 100 re-asserts the associated read wordline 120. As described above, in one embodiment, the asserted read wordline prevents dependent consumer instructions from waking up.

In an alternate embodiment, at some time after an instruction has been selected for execution, system 100 changes the associated bit in latch 130 and PSM 150 gates (turns off) the clock signal feeding latch 130. Thus, PSM 150 prevents the changed bit status from propagating to the associated read wordline, leaving that read wordline unchanged (at logic high). If PSM 150 later determines that the selected instruction has been rejected as a result of a scheduling mis-speculation, system 100 sets the associated bit in latch 130 accordingly and PSM 150 enables the latch 130 clock. If PSM 150 instead determines that the selected instruction has executed, PSM 150 enables the clock signal feeding latch 130, which changes the state of the associated read wordline, as described above.

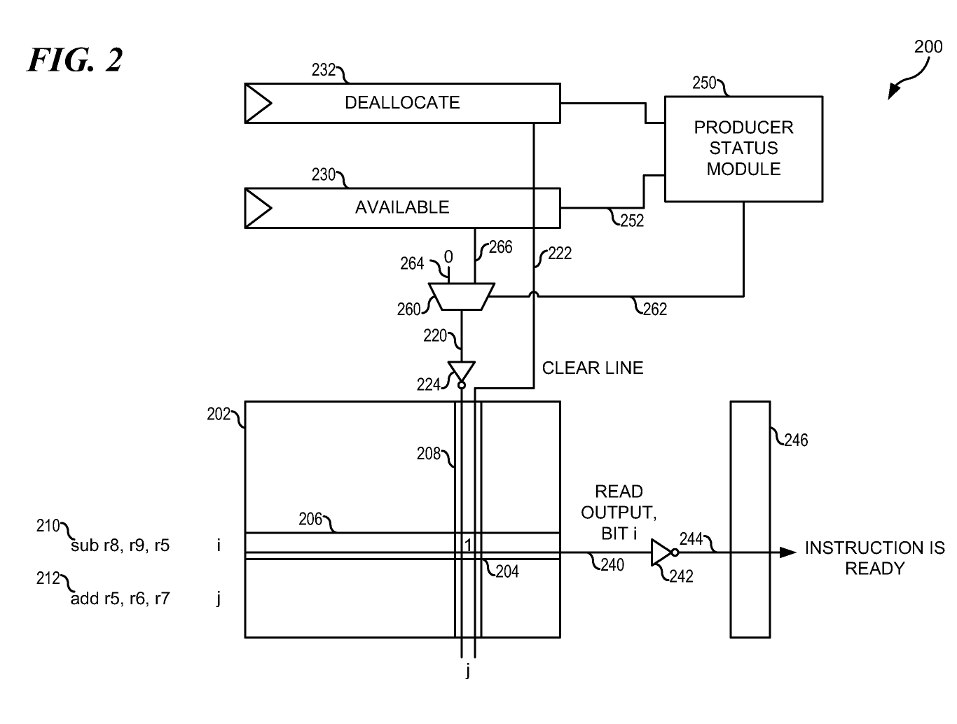

FIG. 2 illustrates an embodiment of an exemplary instruction dependency tracking system 200. Generally, system 200 operates substantially as system 100, modified as described below. Thus, system 200 includes dependency matrix 202, exemplary cell 204, row “i” 206, column “j” 208, instruction 210, instruction 212, read wordline 220, clear line 222, “AVAILABLE” latch 230, inverter 224, read output 240, inverter 242, ready signal 244, ready vector 246, “REALLOCATE” latch 232, producer status module (PSM) 250, and link 252, all of which function in the same manner as their counterpart in FIG. 1.

System 200 also includes an otherwise conventional multiplexer (“mux”) 260, with a select line 262 that couples to PSM 250, modified as described herein. In the illustrated embodiment, PSM 250 is further configured to select between the two inputs to mux 260 through select line 262. Specifically, in one embodiment, mux 260 couples to input 264, which is a permanent logic low (or, in some cases, ground). Mux 260 also couples to input 266, which is the output of latch 230.

As illustrated, system 200 includes a single mux 260. In one embodiment, a corresponding mux 260 couples to each row 208. In an alternate embodiment, mux 260 couples to every row 208, and select line 262 selects between a common input 264 or an individual input 266 that is particular to its associated row 208. For ease of illustration, only one mux 260 is shown.

In one embodiment, at some time after an instruction has been selected for execution, system 200 changes the associated bit in latch 230 and PSM 250 selects input 264, which becomes signal 220 (the un-inverted read wordline for that column. Thus, PSM 250 prevents the changed bit status from propagating to the associated read wordline, leaving that read wordline unchanged (at logic high). If PSM 250 later determines that the selected instruction has been rejected as a result of a scheduling mis-speculation, system 200 sets the associated bit in latch 230 accordingly and PSM 250 selects input 266. If PSM 250 instead determines that the selected instruction has executed, PSM 250 selects input 266, which propagates the changed bit status, thereby changing the state of the associated read wordline, as described above. Accordingly, system 200 reduces the level of speculation introduced by the issue queue, with minimal hardware requirements.

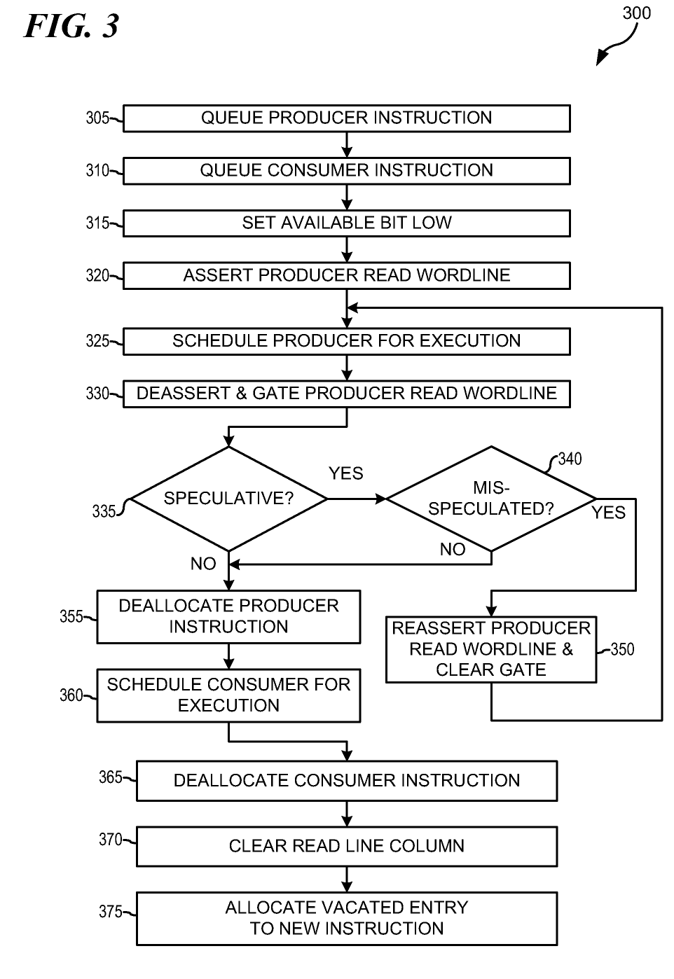

FIG. 3 illustrates one embodiment of a method for improved instruction dependency tracking. Specifically, FIG. 3 illustrates a high-level flow chart 300 that depicts logical operational steps performed by, for example, system 100 of FIG. 1 or system 200 of FIG. 2, which may be implemented in accordance with a preferred embodiment.

As indicated at block 305, the process begins, wherein system 100 queues a producer instruction. In one embodiment, system 100 sets dependency information for the producer instruction in an empty row of dependency matrix 102, row “j”, tracking any dependencies the producer instruction may have. Next, as indicated at block 310, system 100 queues a consumer instruction that depends on the producer instruction. In one embodiment, system 100 queues an instruction by storing the instruction in an issue queue. In one embodiment, system 100 sets dependency information for the producer instruction in an empty row of dependency matrix 102, row “i”. More particularly, system 100 sets the bit in row i corresponding to the producer instruction, which, in one embodiment, is column “j.”

Next, as indicated at block 310, system 100 sets the available bit in latch 130 corresponding to the consumer instruction to a logic low state. Next, as indicated at block 320, inverter 124 inverts the latch 130 output, which asserts the consumer read wordline 120.

Next, as indicated at block 325, system 100 schedules the producer instruction for execution. Next, as indicated at block 330, system 100 deasserts and gates the producer read wordline, which is the read wordline associated with the producer instruction. In one embodiment, system 100 sets the available bit in latch 130 corresponding to the producer instruction to a logic high state. In one embodiment, PSM 150 also gates the clock signal to latch 130. In an alternate embodiment, PSM 250 selects the logic low input 264 of mux 260.

Next, as indicated at decisional block 335, PSM 150 determines whether the producer instruction was scheduled speculatively. If at decisional block 335 PSM 150 determines that the producer instruction was scheduled speculatively, the process continues along the YES branch to decisional block 340. Next, as indicated at decisional block 340, PSM 150 determines whether the producer instruction was mis-speculated. In one embodiment, PSM 150 determines whether the producer instruction was rejected as a result of a scheduling mis-speculation.

If at decisional block 340 PSM 150 determines that the producer instruction was not mis-speculated, the process continues along the NO branch to block 355, described below. If at decisional block 340 PSM 150 determines that the producer instruction was mis-speculated, the process continues along the YES branch to block 350.

Next, as described at block 350, system 100 re-asserts the producer read wordline and clears the gate (if any). In one embodiment, system 100 sets the available bit in latch 130 corresponding to the producer instruction to a logic low state. In one embodiment, PSM 150 also clears the gating off of the clock signal to latch 130. In an alternate embodiment, PSM 250 selects the input 266 of mux 260. The process returns to block 325, wherein system 100 schedules the producer instruction for execution.

If at decisional block 335 PSM 150 determines that the producer instruction was scheduled speculatively, the process continues along the NO branch to decisional block 355. As indicated at block 355, system 100 deallocates the producer instruction. In one embodiment, latch 132 sets to logic high the bit corresponding to the producer instruction's row. In one embodiment, system 100 also clears the producer instruction's row.

Next, as indicated at block 360, system 100 schedules the consumer instruction for execution. Next, as indicated at block 365, system 100 deallocates the consumer instruction. In one embodiment, latch 132 sets to logic high the bit corresponding to the consumer instruction's row. In one embodiment, system 100 also clears the consumer instruction's row.

Next, as indicated at block 370, system 100 clears the producer's read line column. In one embodiment, system 100 also clears the read line column associated with the consumer instruction. In an alternate embodiment, system 100 clears the producer's read line column at block 355. Next, as indicated at block 375, system 100 allocates the entry vacated by the consumer instruction with a new instruction. The process continues as described above.

Thus, generally, systems 100 and 200 provide dependency matrices with improved dependency tracking as compared to prior art systems and methods. Accordingly, the disclosed embodiments provide numerous advantages over other methods and systems, as described herein.

For example, systems 100 and 200 do not modify the array contents (changing either the dependency indication or clearing the read wordline) at a consumer instruction's wakeup time. Instead, in one embodiment, the system does not clear the contents of a producer's read wordline column until the producer's scheduling time is non-speculative and known to be correct. As such, systems 100 and 200 do not require an additional replay queue, which reduces the area required to implement a dependency matrix. Furthermore, neither system 100 nor 200 require additional issue queue write ports, or write port arbitration, for re-inserting instructions into the issue queue. Accordingly, systems 100 and 200 avoid complexity associated with prior art systems and methods.

Additionally, systems 100 and 200 can be configured to gate off the output of the AVAILABLE vector. So configured, systems 100 and 200 can reduce the level of speculation introduced by the issue queue, adding minimal hardware requirements. Systems 100 and 200 therefore also help reduce power consumption and can improve performance by reducing instruction rejections generally.

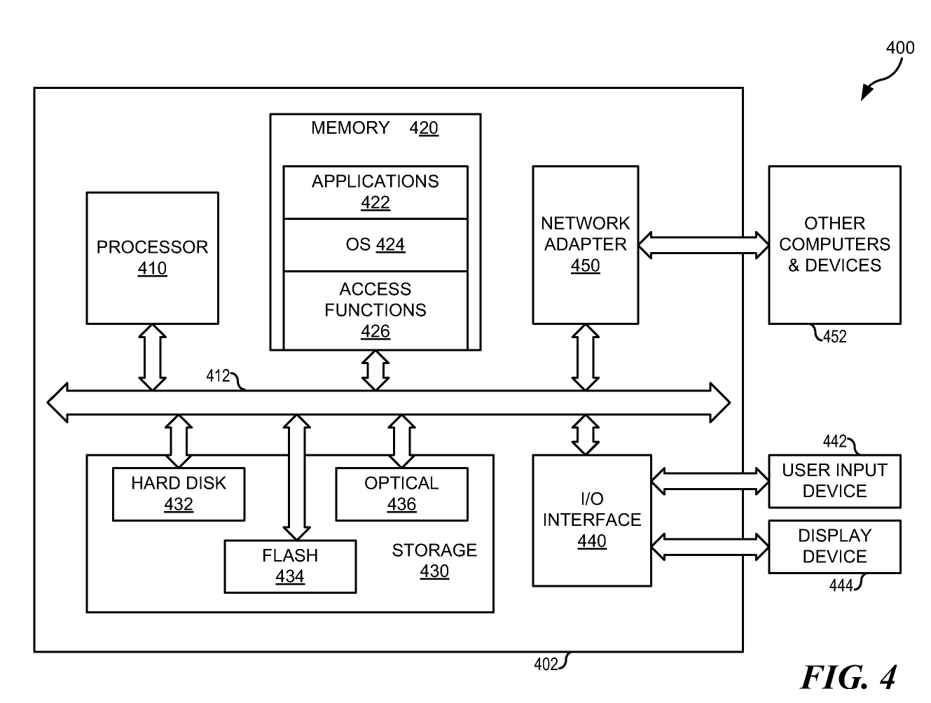

FIG. 4 is a block diagram providing details illustrating an exemplary computer system employable to practice one or more of the embodiments described herein. Specifically, FIG. 4 illustrates a computer system 400. Computer system 400 includes computer 402. Computer 402 is an otherwise conventional computer and includes at least one processor 410. Processor 410 is an otherwise conventional computer processor and can comprise a single-core, dual-core, central processing unit (PU), synergistic PU, attached PU, or other suitable processors.

Processor 410 couples to system bus 412. Bus 412 is an otherwise conventional system bus. As illustrated, the various components of computer 402 couple to bus 412. For example, computer 402 also includes memory 420, which couples to processor 410 through bus 412. Memory 420 is an otherwise conventional computer main memory, and can comprise, for example, random access memory (RAM). Generally, memory 420 stores applications 422, an operating system 424, and access functions 426.

Generally, applications 422 are otherwise conventional software program applications, and can comprise any number of typical programs, as well as computer programs incorporating one or more embodiments of the present invention. Operating system 424 is an otherwise conventional operating system, and can include, for example, Unix, AIX, Linux, Microsoft Windows™, MacOS™, and other suitable operating systems. Access functions 426 are otherwise conventional access functions, including networking functions, and can be include in operating system 424.

Computer 402 also includes storage 430. Generally, storage 430 is an otherwise conventional device and/or devices for storing data. As illustrated, storage 430 can comprise a hard disk 432, flash or other volatile memory 434, and/or optical storage devices 436. One skilled in the art will understand that other storage media can also be employed.

An I/O interface 440 also couples to bus 412. I/O interface 440 is an otherwise conventional interface. As illustrated, I/O interface 440 couples to devices external to computer 402. In particular, I/O interface 440 couples to user input device 442 and display device 444. Input device 442 is an otherwise conventional input device and can include, for example, mice, keyboards, numeric keypads, touch sensitive screens, microphones, webcams, and other suitable input devices. Display device 444 is an otherwise conventional display device and can include, for example, monitors, LCD displays, GUI screens, text screens, touch sensitive screens, Braille displays, and other suitable display devices.

A network adapter 450 also couples to bus 412. Network adapter 450 is an otherwise conventional network adapter, and can comprise, for example, a wireless, Ethernet, LAN, WAN, or other suitable adapter. As illustrated, network adapter 450 can couple computer 402 to other computers and devices 452. Other computers and devices 452 are otherwise conventional computers and devices typically employed in a networking environment. One skilled in the art will understand that there are many other networking configurations suitable for computer 402 and computer system 400.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A processor having a dependency matrix, comprising:
a first array comprising a plurality of cells arranged in a plurality of columns and a plurality of rows;
wherein each row represents an instruction in a processor execution queue;
wherein each cell in the first array represents a dependency relationship between two instructions in the processor execution queue;
a clear port coupled to the first array and configured to clear a column of the first array;
a producer status module coupled to the clear port and the first array and configured to determine an execution status of a producer instruction, wherein the producer instruction is an instruction in the processor execution queue;
an available-status port coupled to the first array and the producer status module and configured to set a read wordline column corresponding to the producer instruction based on the execution status of the producer instruction;
wherein the available-status port is further configured to deassert the read wordline column in response to a selection of the producer for execution;
wherein the available-status port is further configured to reassert the read wordline column in the event the producer status module determines the producer instruction has been rejected; and
wherein the clear port is further configured to clear the column of the first array corresponding to the producer instruction in the event the producer status module determines the producer instruction has been executed.

2. The processor of claim 1, wherein the available-status port further comprises a gate configured to assert and reassert the read wordline column.

3. The processor of claim 1, wherein the available-status port further comprises a gate, the gate comprising:
a 2-input multiplexer (mux) configured to generate a mux output;
wherein a first mux input comprises an available-status bit and a second mux input comprises a logic low input; and
an inverter coupled to the mux output.

4. The processor of claim 1, wherein the available-status port further comprises a gate coupled to the producer status module.

5. The processor of claim 1, wherein the available-status port further comprises a gate coupled to a clock signal.

6. The processor of claim 1, wherein the producer status module is further configured to bias the available-status port.

7. A method for executing an instruction on a computer processor, comprising:
queuing a producer instruction in an instruction queue for execution;
queuing a consumer instruction in the instruction queue for execution, wherein the consumer instruction depends on a result of the producer instruction;
asserting a producer word line, wherein the producer word line prevents scheduling of the consumer instruction when asserted;
scheduling the producer instruction for execution;
deasserting the producer word line;
determining whether a producer source is available; and
in the event the producer source is not available, reasserting the producer word line.

8. The method of claim 7, wherein asserting a producer word line comprises setting an available bit low, wherein the available bit corresponds to the producer instruction.

9. The method of claim 7, further comprising:
in the event the producer source is available:
deallocating the producer instruction from the instruction queue; and
scheduling the consumer instruction for execution.

10. The method of claim 7, further comprising:
in the event the producer source is available, scheduling the consumer instruction for execution.

11. The method of claim 10, further comprising deallocating the consumer instruction from the instruction queue.

12. The method of claim 11, further comprising clearing a read line column corresponding to the producer instruction.

13. A computer program product for executing an instruction on a computer processor, the computer program product stored on a computer usable medium having computer usable program code embodied therewith, the computer useable program code comprising:
computer usable program code configured to determine an object identifier (ID) for each of a first set of objects of a plurality of objects resident in a local memory, to generate a first cache table, the first cache table comprising a plurality of entries, comprising:
computer useable program code for queuing a producer instruction in an instruction queue for execution;
computer useable program code for queuing a consumer instruction in the instruction queue for execution, wherein the consumer instruction depends on a result of the producer instruction;
computer useable program code for asserting a producer word line, wherein the producer word line prevents scheduling of the consumer instruction when asserted;
computer useable program code for scheduling the producer instruction for execution;
computer useable program code for deasserting the producer word line;
computer useable program code for determining whether a producer source is available; and
computer useable program code for in the event the producer source is not available, reasserting the producer word line.

14. The computer program product of claim 13, wherein asserting a producer word line comprises setting an available bit low, wherein the available bit corresponds to the producer instruction.

15. The computer program product of claim 13, further comprising:
in the event the producer source is available:
computer useable program code for deallocating the producer instruction from the instruction queue; and
computer useable program code for scheduling the consumer instruction for execution.

16. The computer program product of claim 13, further comprising:
computer useable program code for in the event the producer source is available, scheduling the consumer instruction for execution.

17. The computer program product of claim 16, further comprising computer useable program code for deallocating the consumer instruction from the instruction queue.

18. The computer program product of claim 17, further comprising computer useable program code for clearing a read line column corresponding to the producer instruction.
